(19) United States
(12) Patent Application Publication
(10) Pub. No.: US 2004/0128007 A1
(43) Pub. Date: Jul. 1, 2004

(54) Golf score management system and golf score managing method

(75) Inventor: Nobuaki Shiratori, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NEOTECH CO., LTD., Tokyo (JP)

(21) Appl. No.: 10/736,495

(22) Filed: Dec. 17, 2003

(30) Foreign Application Priority Data
Dec. 19, 2002 (JP) 2002-367686
Jul. 17, 2003 (JP) 2003-198338

(51) Int. Cl. G06F 155/00

(52) U.S. Cl. 700/91

(57) ABSTRACT

When a golf score is input using a cell phone, the golf score is sent to a server over the Internet. A user searches a desired golf score using the cell phone. A sponsor bears the fee for an online service of a golf score management system for the user, and in return browses the information about the user, and sends an advertising message, etc. to the user. The score information is cross-referenced among users who receive services by the same sponsor.

### BACKGROUND OF THE INVENTION

1. Field of the Invention

The present invention relates to a golf score management system and a golf score managing method, and more specifically to a golf score management system and a golf score managing method for inputting and searching a golf score using a mobile terminal.

2. Description of the Related Art

Conventionally, a golf score has been normally recorded using a score card and a pen. It is well known that since a score card is a paper medium, it is difficult to manage and search a number of scores. Additionally, since a score card is to be small enough to be carried by a player during play of golf, there are restrictions on the amount of data which can be recorded on a score card. Therefore, although a player refers to a recorded score card after his or her play, the player cannot obtain information enough to review his or her play, and the player may not be able to remember a target competition name.

For example, Japanese Patent Application Laid-Open No. 1998-303976 has disclosed a system using a mobile terminal for keeping a golf score. However, in this system, a golf score is only sent to another party during the round of the play through broadcast mail, and the system does not aim at managing and searching an input golf score.

### SUMMARY OF THE INVENTION

The present invention has been developed to solve the above-mentioned problems, and aims at easily inputting and searching a score by inputting a score card using a cell phone.

To solve the above-mentioned problems, the present invention includes a server connected to the Internet, and a mobile communications radio terminal connectable to the Internet. The mobile communications radio terminal includes input means for inputting a golf score, communication means for sending the input golf score to the server over the Internet, and receiving the golf score searched by the server, and display means for displaying the searched golf score.

The golf score management system includes a connected to the Internet, and the searches or edits a golf score stored in the server.

Furthermore, the mobile communications radio terminal is a cell phone.

If a charge is made when the mobile communications radio terminal uses the server, the sponsor terminal receives a charge request from the server, and performs a payment process.

Furthermore, the server allows a plurality of mobile communications radio terminals which are to bear the charge from the sponsor terminal to make cross-reference to the information about golf scores.

A user of the sponsor terminal is a golf course, and the mobile communications radio terminal which bears the charge sends golf score card information to the sponsor terminal through the server.

Furthermore, the present invention is a method for managing a golf score over the Internet between a server and a mobile communications radio terminal, and includes a step of inputting a golf score to the mobile communications radio terminal, a step of sending the input golf score to the server over the Internet, a step of storing the sent golf score in the server, a step of the mobile communications radio terminal inputting a search condition and sending the search condition to the server over the Internet, a step of searching a stored golf score based on the search condition received by the server, and sending search results to the mobile communications radio terminal over the Internet, and a step of displaying the search results by the mobile communications radio terminal.

### BRIEF DESCRIPTION OF THE DRAWINGS

FIG. 1 shows the outline of the golf score management system according to the first embodiment of the present invention;

FIG. 2 is a block diagram of the cell phone according to the first embodiment of the present invention;

FIG. 3 is a transition chart of the screen of the golf score management system according to the first embodiment of the present invention;

FIG. 4 shows the LOGIN screen, the LOGIN error screen, the LOGIN timeout screen, and the menu screen according to the first embodiment of the present invention;

FIG. 5 shows an input new score screen according to the first embodiment of the present invention;

FIG. 6 shows the search past score screen, the search result screen, the display list screen, the display detail screen, and the individual delete screen according to the first embodiment of the present invention;

FIG. 7 shows the update user information screen and the collective delete screen according to the first embodiment of the present invention;

FIG. 8 is a flowchart of the operation of the golf score management system according to the first embodiment of the present invention;

FIG. 9 is a flowchart of the operation of the golf score management system according to the first embodiment of the present invention;

FIG. 10 shows the search and edit screen on the personal computer according to the first embodiment of the present invention;

FIG. 11 shows the outline of the golf score management system according to the second embodiment of the present invention;

FIG. 12 shows the screen for a display user information function according to the second embodiment of the present invention;

FIG. 13 shows the screen for an edit function according to the second embodiment of the present invention;

FIG. 14 shows the screen for a communication function for a sponsor according to the second embodiment of the present invention;

FIG. 15 shows the screen for a submit score card function according to the second embodiment of the present invention;

FIG. 16 shows the screen for a list score data function according to the second embodiment of the present invention;

FIG. 17 shows the screen for a group function according to the second embodiment of the present invention; and

FIG. 18 shows the screen for a group function according to the second embodiment of the present invention.

### DETAILED DESCRIPTION OF THE PREFERRED EMBODIMENTS

Embodiment of the present invention is described below by referring to the attached drawings.

<First Embodiment>

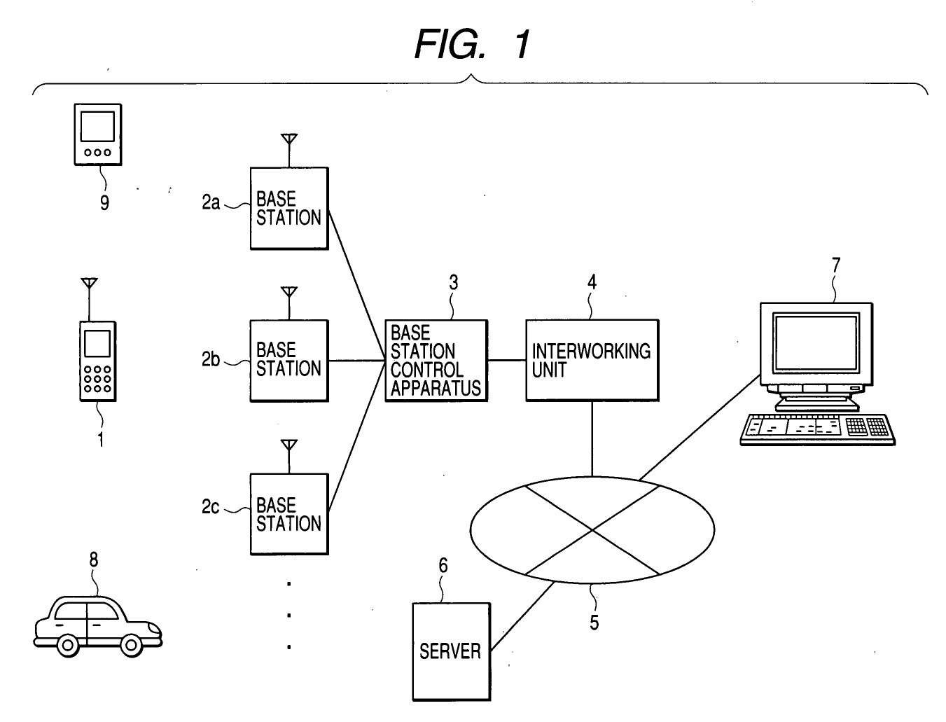

FIG. 1 shows the outline of the golf score management system according to the first embodiment of the present invention. As shown in FIG. 1, the golf score management system comprises a cell phone 1, a base stations 2a to 2b, a base station control device 3, an interworking unit 4, the Internet 5, a server 6, a personal computer 7, a car navigation system 8, a PDA (personal data assistant) 9, etc. The cell phone 1 has the Internet connection capability in addition to the common voice dialog capability, and carried by a golf player. The base stations 2a, 2b, and 2c are provided in a plurality of wireless service areas sectioned in polygon form, and perform wireless communications with the cell phone 1. When the cell phone 1 moves, a so-called handover is performed, to establish wireless communications with a base station which can establish the strongest wireless communications among the base stations 2a, 2b, and 2c with the cell phone 1. The base stations 2a, 2b, and 2c, etc. are connected to the base station control device 3, and the base station control device 3 controls the handover process on the base stations 2a, 2b, and 2c.

The interworking unit 4 is connected between the base station control device 3 and the Internet 5, and enables the communications between a wireless communications system and the Internet 5 by mapping the information element of each layer between the communications protocol of the wireless communications system of the cell phone 1, the base stations 2a, 2b, and 2c, etc. and the communications protocol of the Internet 5. The server 6 receives golf score data sent from the cell phone 1 over the Internet 5, stores the data, and provides various services such as a search, etc. of golf score data for the cell phone 1. The personal computer 7 accesses the server 6 over the Internet 5, and can be used to search and edit golf score data.

The car navigation system 8 has a communication function, and can access the server 6 through the base stations 2a to 2c. The car navigation system 8 also has the voice synthesis capability, and can read a golf score. The PDA 9 also has a communication function, and can input and search a golf score lime the cell phone 1.

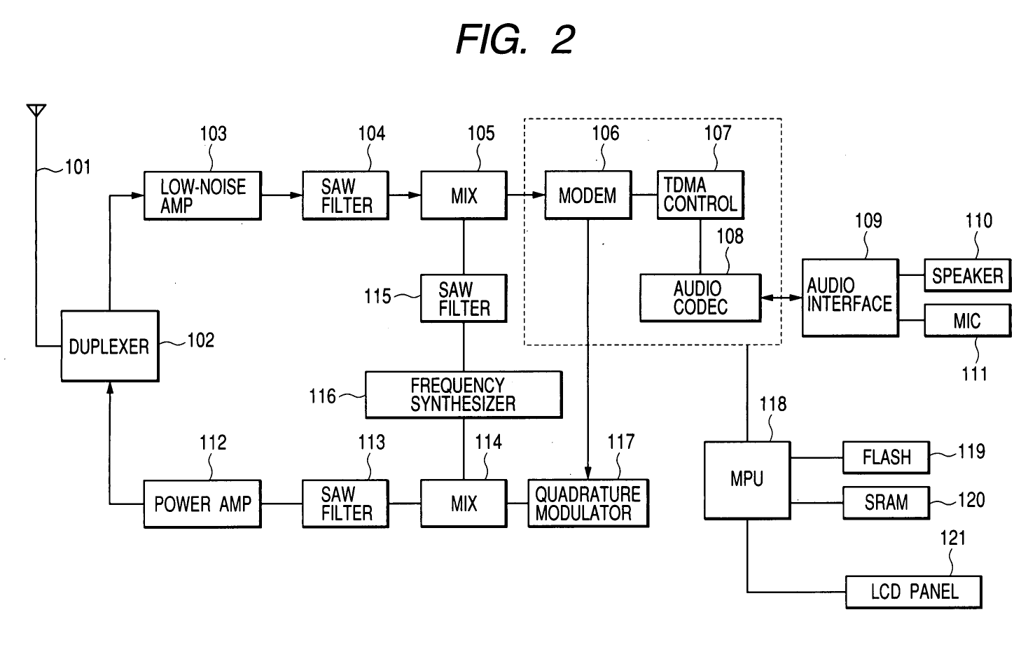

FIG. 2 is a block diagram of the cell phone 1. As described above, the cell phone 1 has the Internet connection capability. For the Internet connection capability, the cell phone 1 is provided with an MPU 118, flash memory 119, SRAM 120, an LCD display, etc. An LCD display 121 displays a LOGIN screen, an input screen, an edit screen, a search screen for a golf score as described later. The cell phone 1 is also provided with an antenna 101, a duplexer 102, a low noise amplifier 103, a SAW filter 104, a MIX circuit 105, a modem circuit 106, a TDMA control circuit 107, a voice CODEC 108, a voice interface 109, a speaker 110, a microphone 111, a power amplifier 112, a SAW filter 113, a MIX circuit 114, a SAW filter 115, a frequency synthesizer 116, a D/A converter 117, etc.

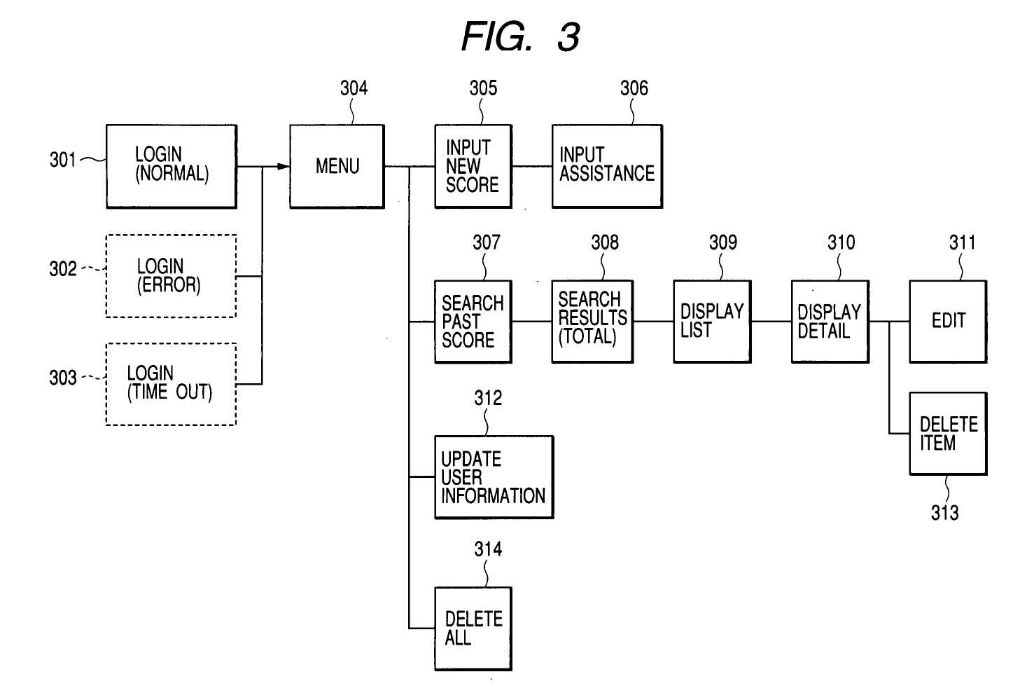

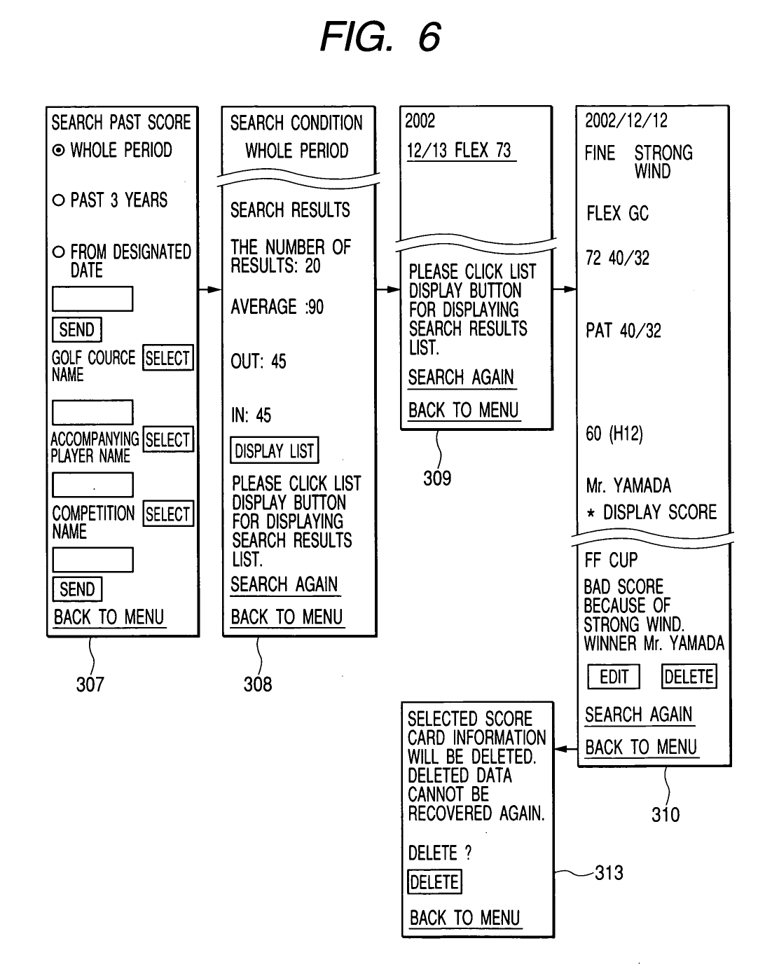

Then, an example of the display screen of the cell phone 1 is explained below by referring to FIGS. 3 through 7. FIG. 3 shows the transition of the display screen. When a player accesses a predetermined URL over the Internet using the cell phone 1, a LOGIN screen 301 is displayed. The LOGIN screen 301 includes a user ID input field, a password input field, a LOGIN button, and a simple explanation of a golf score input system. An identifier unique to a user is input to the user ID input field, and an arbitrary user-set alphanumeric is input to the password input field.

A LOGIN error screen 302 is displayed when there is an error in an input user ID or password. The LOGIN error screen 302 includes a message displayed when there is an error in a user ID input field, a password input field, a LOGIN button, a user ID, etc., and a message indicating that an acceptable character is a half-width alphanumeric only.

A LOGIN timeout screen 303 is displayed when no input or inquiry is made to a score within a predetermined time (for example, 30 minutes) after LOGIN. When the screen is displayed, LOGOFF is forcibly performed by the server, it is necessary to perform a LOGIN procedure again. The LOGIN timeout screen 303 includes a user ID input field, a password input field, a LOGIN button, a message indicating LOGOFF, and a prompt message for a LOGIN process again.

A menu screen 304 is located at the highest order of each screen in a hierarchical structure, and is first displayed when a LOGIN process is performed. The menu screen 304 includes a link display to the input new score screen, a link display to the update user information screen, a link display to the search past score screen, a link display to the collective delete score screen, a message indicating a top menu, and a simple message of the menu.

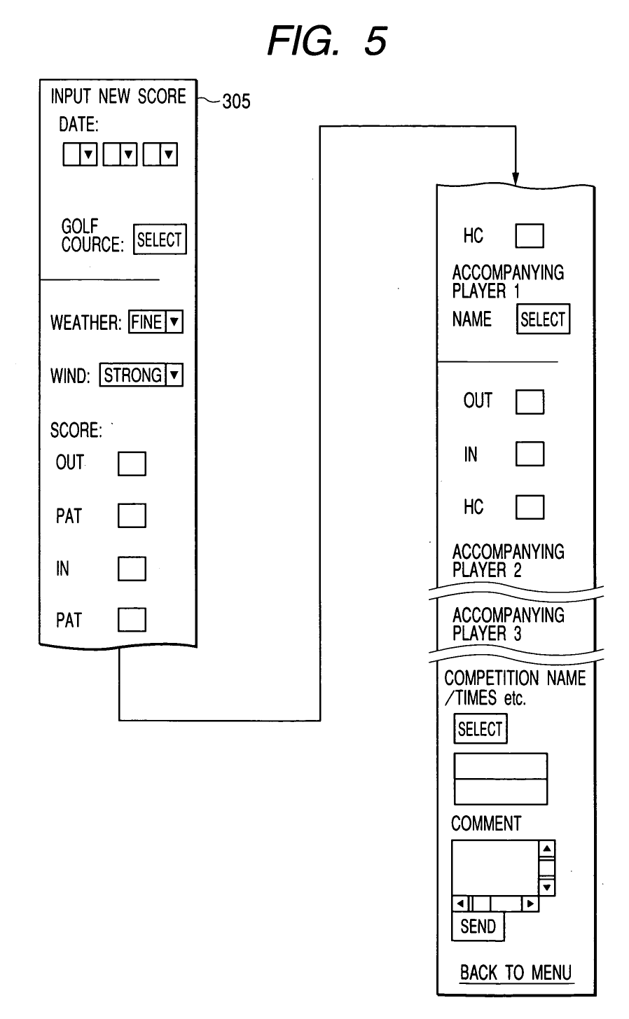

FIG. 5 shows an input new score screen 305. The input new score screen 305 shows the input of scores of the user and his or her accompanying player. The input new score screen 305 includes as play data of play information “date”, “golf course”, “weather”, “wind”, “accompanying player”, “competition information”, and “comment”, and includes as score data “out score”, “in score”, “handicap”, and “count of pats”.

In the play data, “date” is selected from the list on which digits indicating the year, month, and day are selected. Since the year, month, and day of the date of the play are defaulted, the user normally inputs an arbitrary character string to the input field of the “golf course”. When “select button” is clicked, the past input golf course names are listed, and the user can select a desired golf course from the list. As a selection list of “weather”, for example, “fine”, “cloudy”, and “rainy” are prepared, and “strong”, “weak”, and “none” are prepared as a selection list of wind. Arbitrary characters can be input to the input fields of “accompanying player” and “competition name”. When the “select button” is clicked, the past input names are listed, and the names selected from the list are automatically written to the input field. The “send button” is used to send an input search condition to the server 6, and the “back to menu” at the lower portion of the screen is a link button to the menu screen 304.

A search result screen 308 displays search results based on the search condition specified by a search past score screen 307. A search condition (for example, an entire period, etc.) is displayed at the upper portion of the screen, and followed by search results. “The number of results” indicates the number of score cards corresponding to search condition, and “average”, “out”, and “in” indicate the average value of the scores of the number of score cards, the average value of the out scores, and the average value of the in scores. When “search again” at the lower portion of the screen is clicked, control is returned to the search past score screen 307. When “back to menu” is clicked, control is returned to the menu screen 304. When “display list” is clicked, a display list screen 309 is displayed.

The display list screen 309 displays a list of searched scores, and displays a list of scores of the number of searched scores. “12/13 flex 73” at the upper portion of the screen displays “date”, “golf course name”, and “score (gross)”. The display indicates the link to a display detail screen 310. When the display is clicked, the display detail screen 310 is displayed.

The display detail screen 310 shows the details selected on the display list screen 309. The screen includes output fields of “date”, “weather”, “wind”, “golf course name”, “net”, “out”, “in”, “count of pats (out)”, “count of pats (in)”, “gross”, “handicap”, “accompanying player name”, “competition information”, “auxiliary information for competition”, “comment”, etc. The output fields are also prepared for the scores of the user and his or her accompanying player. The “edit button” at the lower portion of the screen is a link display to an edit screen 311, and “delete button” is a link display to an individual delete screen.

The individual delete screen 313 is displayed when the score card selected on the display detail screen 310 is deleted. When the “delete button” at the lower portion of the screen is clicked, the data relating to the selected score card is deleted from the server 6.

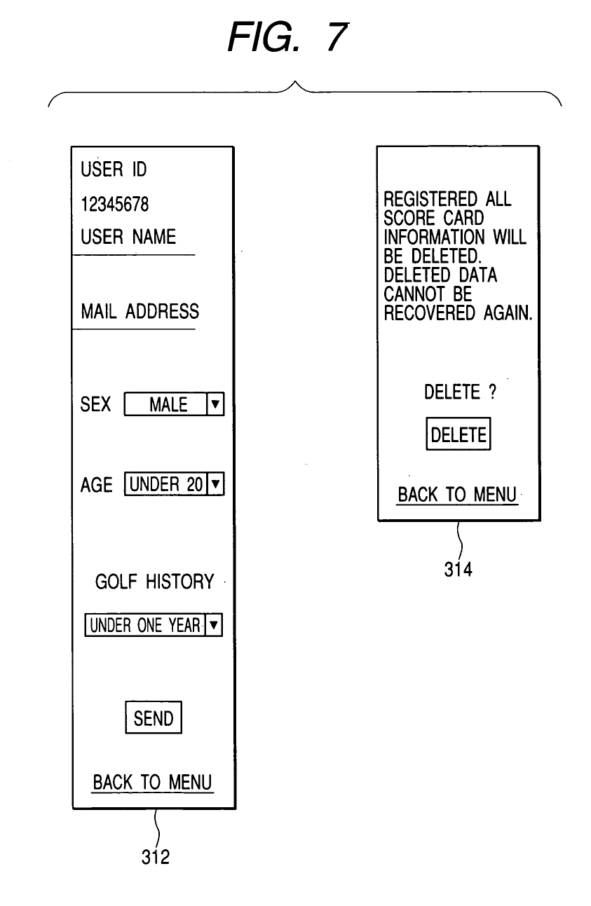

FIG. 7 shows an update user information screen 312 and a collective delete screen 314. The update user information screen 312 is used to register and update the information about the user. On the screen, “user name”, “mail address”, “sex”, “age” and “golf history” can be registered. The input data can be sent to the server 6 by pressing “send button”, and can be recorded on the hard disk in the server 6.

The collective delete screen 314 is used to delete all data relating to the registered score card. By clicking “delete button” at the lower portion of the screen, the data relating to the score card stored in the server 6 is completely deleted.

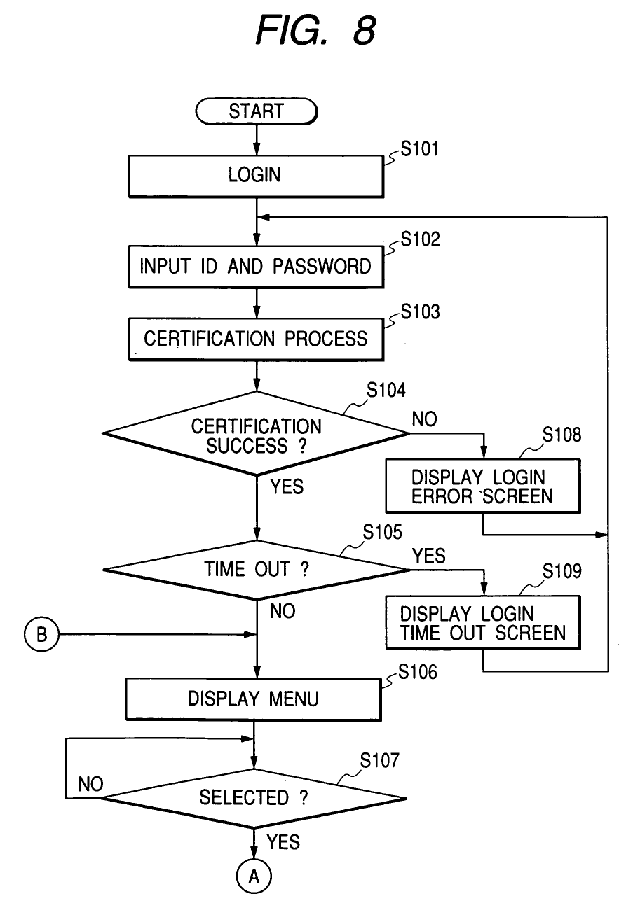

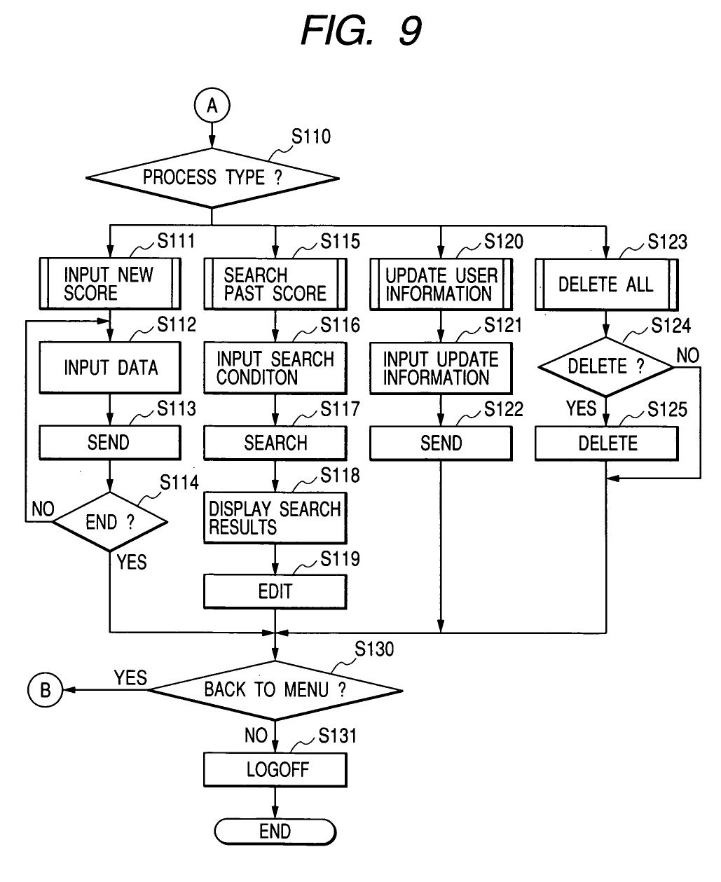

Then, the operation of the golf score input system according to the present embodiment is described below by referring to FIGS. 8 and 9. First, when the user operates the cell phone 1, and accesses a predetermined URL (uniform resource locator), the LOGIN screen 301 is input to the LCD display 121 of the cell phone 1 (step S101). The user writes the user ID and password registered in advance to the input field of the LOGIN screen 301, and clicks the “LOGIN button” (step S102). The server 6 makes an authentication check whether or not the user ID and the password received from the cell phone 1 are correct (step S103). When the user ID or the password is not correct (NO in step S104), the server 6 sends the LOGIN error screen 302 to the cell phone 1 (step S108). The player can input a correct user ID and password on the LOGIN error screen 302, and the server 6 performs the authentication process again (step S108).

When the input user ID and password are correct (YES in step S104), the server 6 permits LOGIN of the player. Then if no input is made by the player (YES in step S105), a timeout occurs, and the LOGIN timeout screen 303 is displayed on the cell phone 1 (step S109). The player can perform again a LOGIN process on the screen (in and after step S102).

After the LOGIN process is normally performed, the server 6 sends the menu screen 304 to the cell phone 1, and prompts the player to select any service in the menu (step S106). When a desired process is selected by a player (YES in step S107), the screen corresponding to the selected process is displayed on the cell phone 1 (steps S111, S115, S120, and S123).

In step S110, when “input new score” is selected (step S111), the input new score screen 305 is displayed on the cell phone 1. On the screen, the player inputs the scores of the player and the accompanying player in addition to the information such as “date”, “golf course”, “weather”, “wind”, etc. (step S112), and clicks the “send button” (step S113). The server 6 stores the sent data as the score card data of the player. Until the player has completely input the scores (YES in step S114), the processes in steps S112 and S113 are repeated.

In step S110, when the search past score screen process is selected (step S115), the search past score screen 307 is displayed on the cell phone 1. On this screen, when the player makes predetermined input (step S116), and clicks the “send button”, the server 6 starts searching desired data from the stored data of the score card (step S117). The search results are displayed on the search result screen 308, the display list screen 309, and the display detail screen 310 (step S118). For example, when the score cards for the past 3 years are specified, the number of results of the score cards corresponding to the condition, the average score, etc. are displayed on the search result screen 308, and the details of each score card can also be displayed on the display list screen 309 and the display detail screen 310. The player can edit or amend the past score card on the edit screen 311 (step S119).

In step S110, when the update user information screen process is selected (step S120), the display detail screen 310 is displayed on the cell phone 1, and the player can edit, for example, add a comment, etc. The contents of edition are sent to the server 6 by clicking “send button”, and stored on the hard disk of the server 6.

In step S110, when the collective delete screen process is selected (step S123), the collective delete screen 314 is displayed on the cell phone 1. When the player clicks the “delete button” (YES in step S125), the server 6 clears all score data of the player (step S125).

When the player clicks the link button of “back to menu” at the lower portion of each screen after the above-mentioned processes have been completed (YES in step S130), the menu screen 304 is displayed on the cell phone 1. On the other hand, if no operation is performed for a predetermined time without clicking the link button of “back to menu”, the LOGOFF process is automatically performed (step S131).

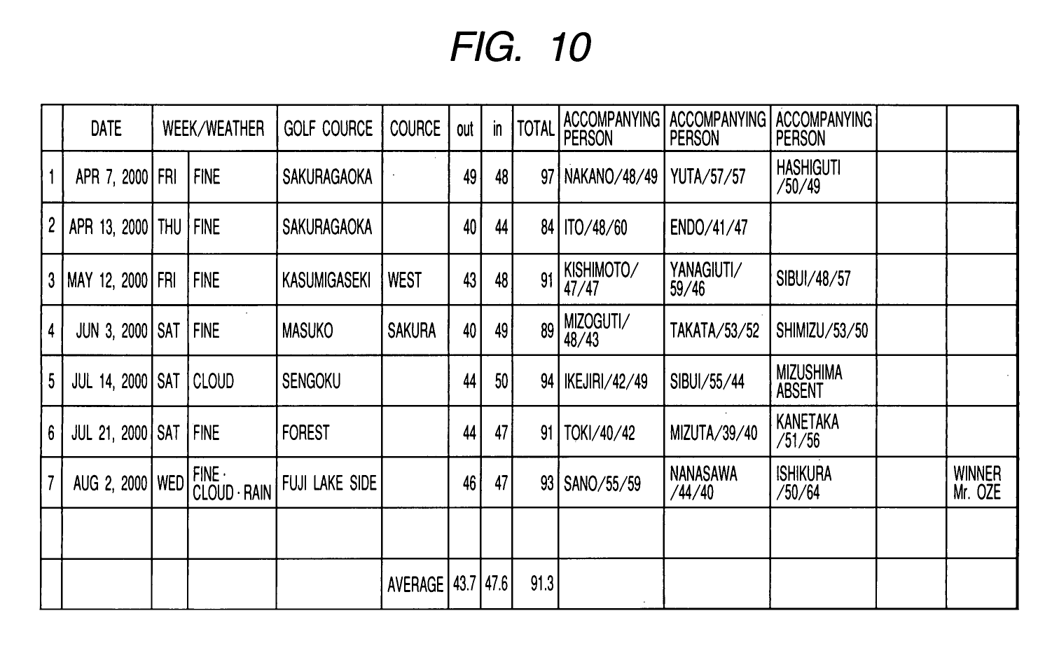

FIG. 10 shows an example of a search and edit screen of a golf card using the personal computer 7. In the present system, a player can search and edit a score card using the personal computer 7. Thus, the player can access data from both the cell phone 1 and the personal computer 7.

As described above, according to the present invention, a score can be easily input and searched by inputting a score card on the cell phone. Additionally, by recording a score card on the server over the Internet, a score card can be searched and edited using the personal computer.

<Second Embodiment>

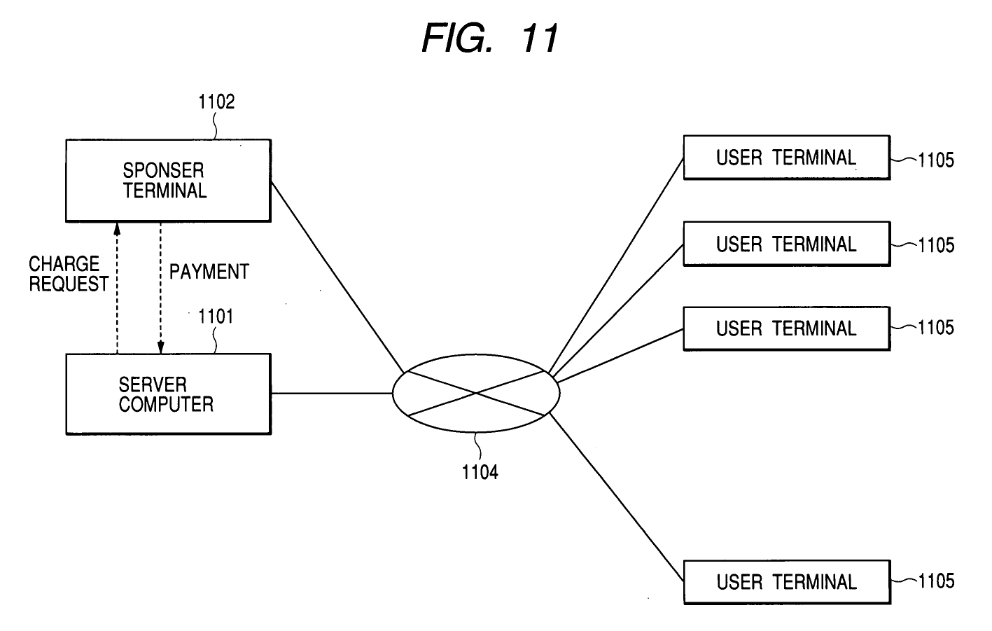

Described below is the golf score management system according to the second embodiment of the present invention. FIG. 11 shows the outline of the golf score management system according to the second embodiment of the present invention. The golf score management system comprises a server computer 1101, a sponsor terminal 1102, and a user terminal 1105.

The user terminal 1105 comprises a cell phone, a PCA, a personal computer, etc. for inputting and searching a golf score and receiving an online service. The server computer 1101 has the function of providing various online services by adding up the golf score data input from the user terminal 1105 comprising a cell phone. The sponsor terminal 1102 is operated by a sponsor, and comprises a cell phone, a PDA, and a personal computer. The sponsor bears the charge amount for the charge request to the user terminal 1105 from the server computer 1101. That is, when the user terminal 1105 receives an online service from the server computer 1101, the server computer 1101 sends a charge request including charge amount information to the sponsor terminal 1102 over a network 1104. Then, the sponsor terminal 1102 performs the payment process corresponding to the charge request. The method of performing the payment process can be an online payment, a direct payment in cash, etc.

On the other hand, instead of bearing the charge for the online service, the sponsor can check and use the user information. The sponsor can expand his or her business by sending a message such as advertisements to the user terminal 1105. In the golf score management system according to the present embodiment, the sponsor is assumed to be a golf course.

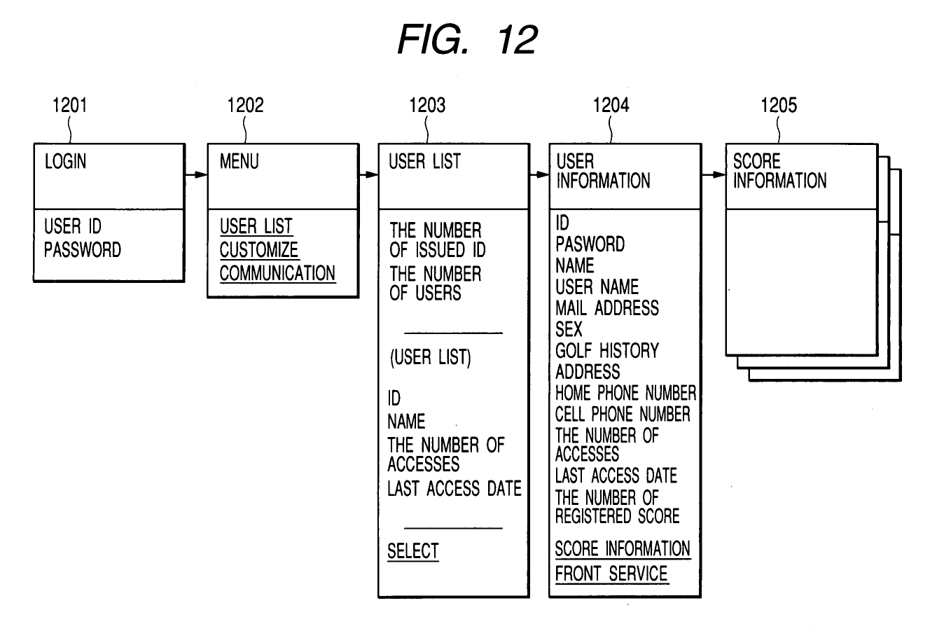

FIG. 12 shows the screen for the display user information function for a sponsor. The screen is displayed on the sponsor terminal 1102, and formed by a LOGIN screen 1201, a menu screen 1202, a user list screen 1203, a user information screen 1204, and a score information screen 1205.

When the sponsor inputs a user ID and a password on the LOGIN screen 1201, the menu screen 1202 is displayed on the sponsor terminal 1102. The menu screen 1202 includes user list, customize, and communication items, and the sponsor can select a desired item from among them. The selection of an item is performed by clicking an underlined item on the screen. Depending on the selected item, any of the user list screen 1203, the user information screen 1204, and a score screen 1205.

The user list screen 1203 displays as user list information an ID, a name, the number of accesses, and the last access date of each user in addition to the number of issued IDs and the number of users. When the sponsor selects any user from a user list, the user information screen 1204 including the detailed information about the user is displayed. The user information screen 1204 includes an ID, a password, a name, a user name, a mail address, sex, a golf history, an address, a home phone number, a cell phone number, the number of access, the last access date, the number of registered scores, score information, and a front service. Among these items, when the score information and front service items are clicked, further detailed information (score information screen 1205, etc.) is displayed. The sponsor can analyze sending direct mail, the age, etc. of a user who receives a service, etc.

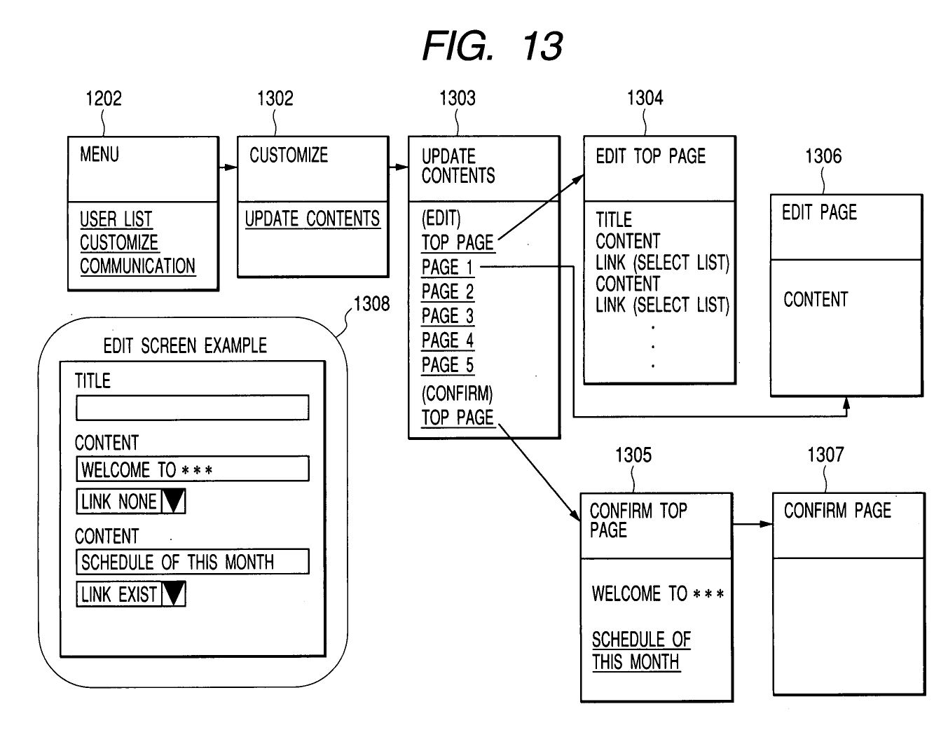

FIG. 13 displays the screen for the edit function of a sponsor. The screen is used in editing the display screen of a user. When the sponsor clicks the customize item on the menu screen 1202, a customize screen 1302 is displayed. Furthermore, when the update contents item is clicked on the customize screen 1302, an update contents screen 1303 is displayed. The update contents screen 1303 displays the page names of the top page, page 1, page 2, etc. forming the contents screen for a user. When the sponsor clicks any of the page names, the edit screen of a corresponding page is displayed. For example, when the top page is clicked, an edit top page screen 1304 is displayed. The screen is used in editing the top page of the contents, and the sponsor can freely edit the title, contents, link, etc.

When the item on page 1 of the update contents screen 1303 is clicked, an edit page screen 1306 is displayed, and the contents of page 1 of the contents can be freely edited. If the confirm item on the update contents screen 1303 is clicked after the editing operation is completed, confirm screens 1305 and 1307 after the editing operation is displayed. The actual contents screen can be confirmed by referring to the confirm screens 1305 and 1307. Thus, through the editing operation, for example a screen 1308 is generated.

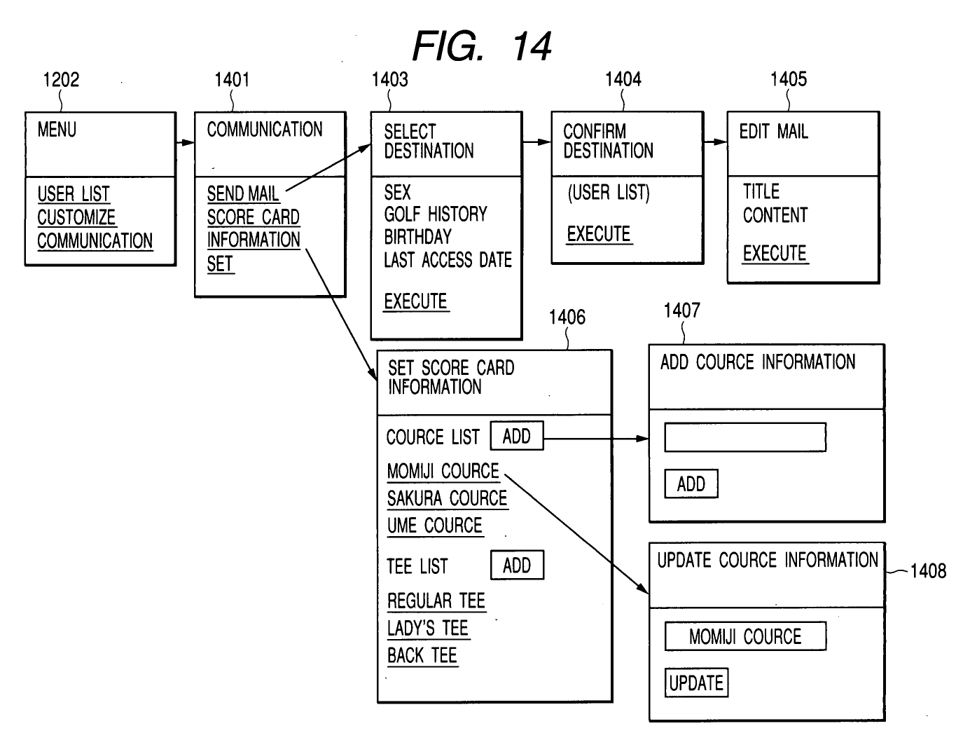

FIG. 14 shows the screen indicating the communication function for a sponsor. The screen is used in sending mail from a sponsor to a user, and setting information about a score card. When the sponsor clicks the item of the communications on the menu screen 1202, a communication screen 1401 is displayed. Furthermore, when a send mail item is clicked on the communication screen 1401, a select destination screen 1403 is displayed.

The sponsor determines a destination user by specifying the sex, golf history, birthday, last access date of the user on the select destination screen 1403. For example, when a user with his or her birthday approaching is specified, the list of users corresponding to the condition is displayed on a confirm destination list screen 1404. Then, the sponsor generates mail on the edit mail screen, and clicks the execute item on the screen, thereby sending the mail to the specified user. For example, mail relating to a birthday bonus service can be sent to a user with his or her birthday approaching.

Furthermore, when a set score card information item is clicked on the communication screen 1401, a set score card information screen 1406 is displayed. The set score card information screen 1406 is used in editing the input score card screen displayed on the user terminal 1105. When the add item on the set score card information screen 1406 is clicked, the add course information screen 1407 is displayed. By inputting a new course name on the add course information screen 1407, a golf course displayed on the input score card screen can be added. Furthermore, on the set score card information screen 1406, by clicking the registered golf course name, the course information can be edited on an update course information screen 1408.

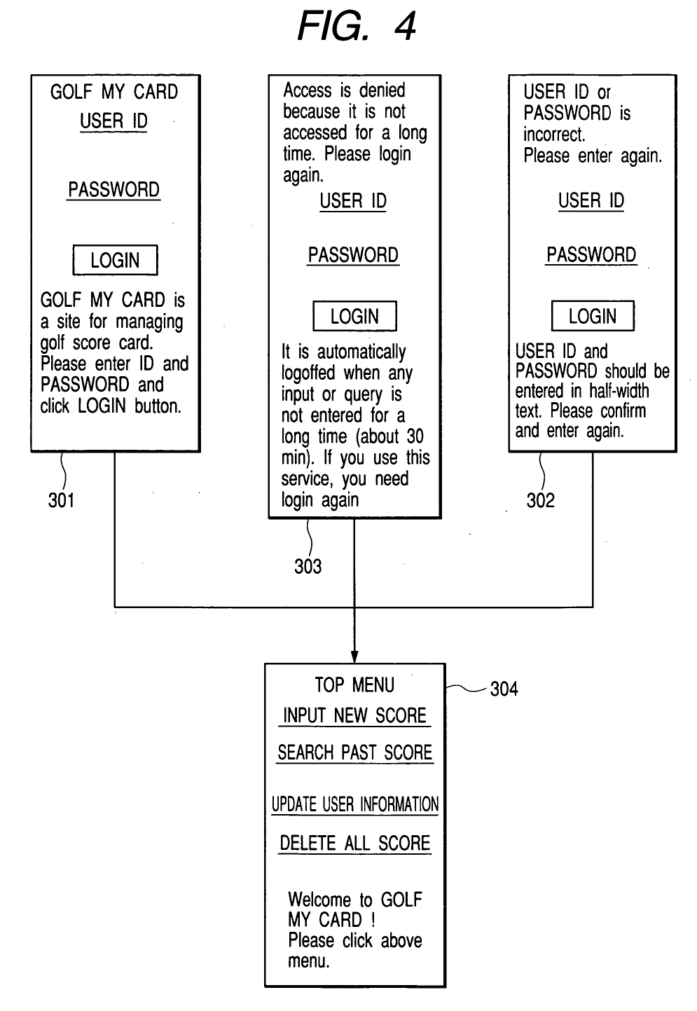

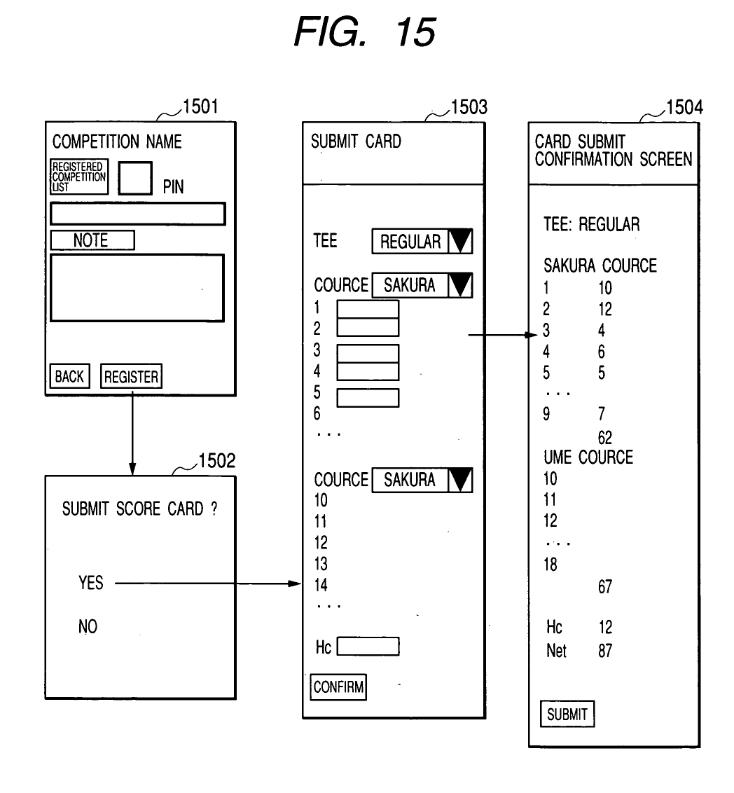

FIG. 15 shows the screen for the submit score card function. When a sponsor is a golf course, the user can send a score card to the golf course using the user terminal 1105 in the golf course. When the user clicks the input new score item on the top menu 304 shown in FIG. 4 on the user terminal 1105, and selects the submit score function, an input competition name screen 1501 is displayed on the user terminal 1105. When the user inputs the competition name, note, etc. on the screen, and clicks the register button, a confirm screen 1502 is displayed. The confirm screen 1502 is used in allowing a user to select submit score function. When the user selects the submit score function, a submit card screen 1503 is displayed. The submit card screen 1503 includes each of the items of select tee, select the name of a course, input a score, and handicap. After the user inputs a necessary item to the items and clicks the confirm item, a card submit confirmation screen 1504 is displayed on the user terminal 1105. The card submit confirmation screen 1504 is used in confirming an item input on the submit card screen 1503. When the user clicks the confirm item on the card submit confirmation screen 1504 after confirming the input items, the information about the score card is sent to the sponsor terminal 1102 through the server computer 1101.

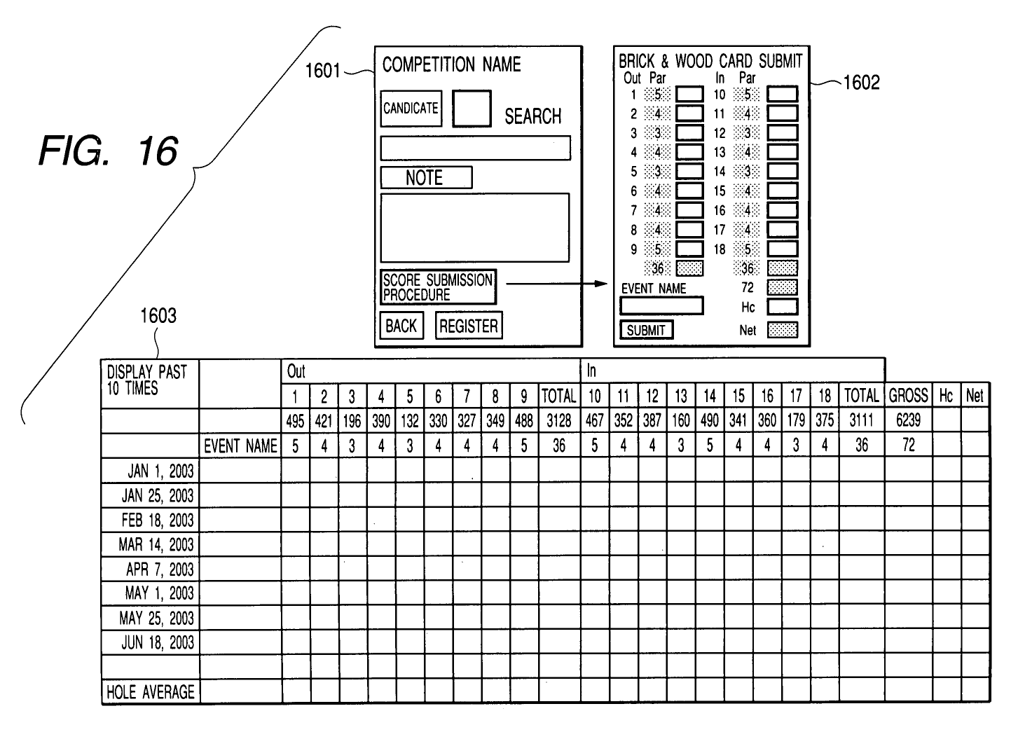

FIG. 16 shows the screen for the list score data function. The list score data function is to provide score data of the past 10 competitions. The information about the score cards presented by a user using the above-mentioned submit score card function is accumulated in the server computer 1101. That is, the information about the score card input on screens 1601 and 1602 is provided for the user as score data list information 1603. The score data list information can be provided by sending to the user terminal 1105, directly handing in as printout, etc. Since score data list information 1608 includes the information about the play date and the golf score information of the past 10 competitions, the user can immediately grasp the past scores.

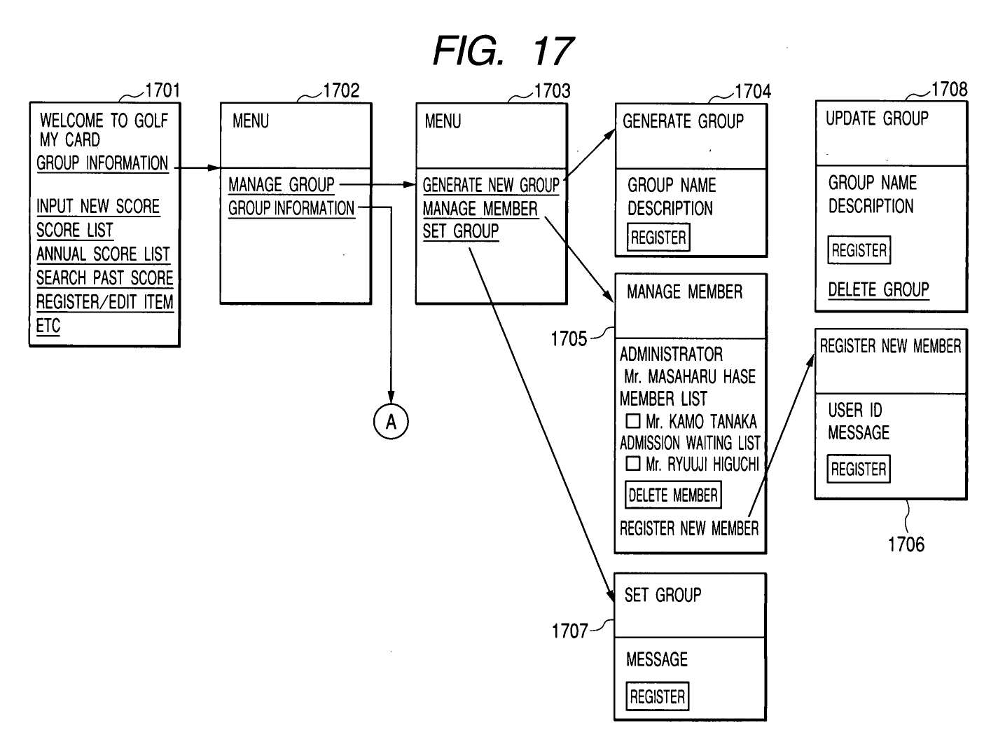

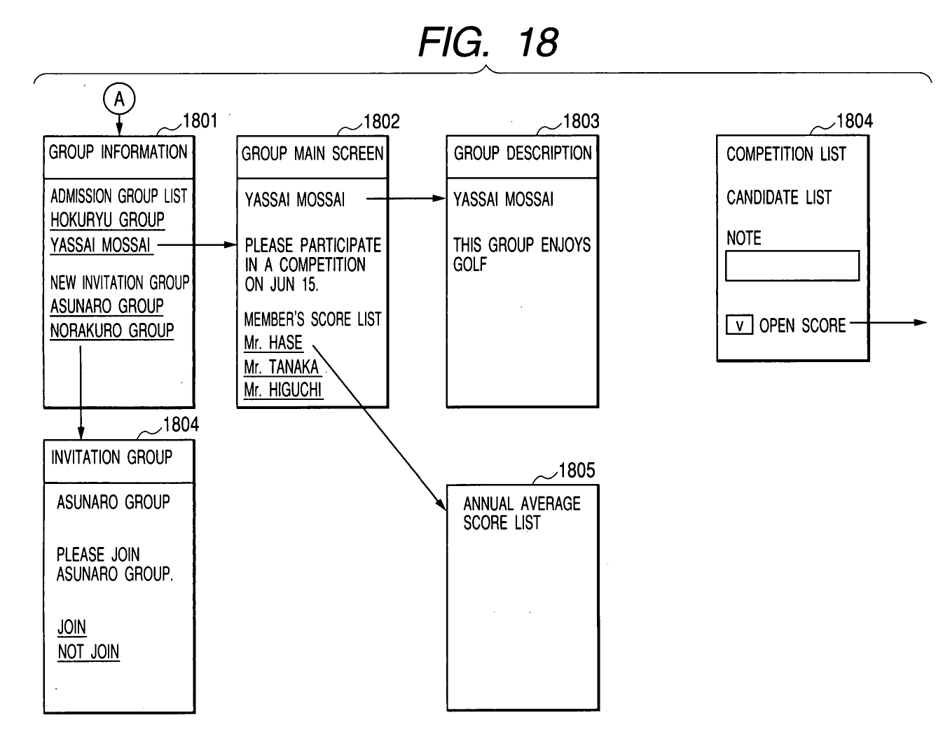

FIGS. 17 and 18 show the screens for the group function. Using the group function, the score information can be cross-referenced among a plurality of users, a message can be broadcast-distributed, etc.

In FIG. 17, when the user selects the group information item from a top menu 1701, a menu 1702 is displayed on the user terminal 1105. Manage group and group information items are included on the menu 1702. When the user selects the managing group item, menu screens 1703 to 1708 for management of the registration of a member, etc. are displayed. When a group information item is selected, screens 1801 to 1805 for display of a score, etc. of each member are displayed.

The menu screen 1703 includes each of the generate new group, the manage member, the set group. When the generate new group item is selected, the generate group screen 1704 is displayed. The generate group screen 1704 is used in registering a group name, and descriptions. When the delete group item is clicked on the update group screen 1708, the settings of the group is deleted.

When the manage member item is selected on the menu screen 1703, the manage member screen 1705 is displayed on the user terminal 1105. The manage member screen 1705 is the screen for management of registration and deletion of a member, and includes the administrator, member list, approval-awaiting member list items. When a new member is registered, a user inputs a user ID of a new member and a message on the register new member screen 1706, and clicks the register button.

When the set group item is selected on the menu screen 1703, the set group screen 1707 is displayed. The set group screen 1707 is used in registering a message displayed on the group information screen. For example, when a message relating to an invitation to a golf competition is registered, the message can be sent only to the members of the group.

On the other hand, when the group information item is selected on the menu screen 1802, the group information screen 1802 is displayed on the user terminal 1105. On the group information screen 1801, the name of a registered group, and the name of a newly invited group are displayed. For example, when a “norakuro group” item in the newly invited groups is clicked, the group invitation screen 1804 for invitation to the group is displayed.

On the group information screen 1801, when a user clicks the group name of “yassai mossai” in the registered group list, the group main screen 1802 is displayed. A group name, an invitation to a group competition, a member score list are displayed on the menu screen 1802. On the screen, when a user clicks a group name, the group description screen 1803 is displayed. When an arbitrary member name in the member score list is clicked on the group main screen 1802, the annual average score list screen 1805 of the member is displayed. Thus, the score of a member belonging to the same group can be referred to. When a registered member in the group does not want to open his or her score, the check box to open the score is removed on the group invitation screen 1804, thereby suppressing the disclosure of the score.

Other functions according to the present embodiment are similar to those according to the first embodiment. That is, a score can be input and listed, a past score can be searched for, a database can be edited, etc.

The present invention is not limited to the above-mentioned embodiments, but can be amended without departure from the gist of the present invention. For example, a user can send a golf score to a plurality of friends registered in the cell phone to open his or her score. Thus, the effect of advertisements to those not registered in the golf score management system can be expected, thereby successfully increasing the subscribers to the system. Furthermore, by sending a golf score to the car navigation system 8, the existence of the system can be announced to car drivers and users. A golf score can also be displayed and searched using a car navigation system.

What is claimed is:

1. A golf score management system, comprising:
a server connected to the Internet; and
a mobile communications radio terminal connectable to the Internet, wherein
said mobile communications radio terminal comprises:
input means for inputting a golf score;
communication means for sending the input golf score to said server over the Internet, and receiving the golf score searched by said server; and
display means for displaying the searched golf score.

2. The system according to claim 1, further comprising
a fixed terminal connected to the Internet, wherein
said fixed terminal searches or edits a golf score stored in said server.

3. The system according to claim 1, wherein
said mobile communications radio terminal is a cell phone.

4. The system according to claim 1, further comprising
a sponsor terminal for receiving a charge request from said server, and performing a payment process if a charge is made when said mobile communications radio terminal uses said server.

5. The system according to claim 4, wherein
said sponsor terminal can receive personal information about a user of said mobile communications radio terminal from said server.

6. The system according to claim 4, wherein
said server allows golf score information to be cross-referenced among a plurality of mobile communications radio terminals on which said sponsor has performed a payment process.

7. The system according to claim 4, wherein
a user of said sponsor terminal is a golf course, and said mobile communications radio terminal which bears the charge sends golf score card information to said sponsor terminal through said server.

8. A method for managing a golf score between a server and a mobile communications radio terminal over the Internet, comprising:
a step of inputting a golf score to the mobile communications radio terminal;
a step of sending an input golf score to said server over the Internet;
a step of said server storing the sent golf score;
a step of said mobile communications radio terminal inputting a search condition and sending the search condition to said server over the Internet;
a step of searching a golf score stored based on the search condition received by said server, and sending search results to said mobile communications radio terminal over the Internet; and
a step of said mobile communications radio terminal displaying the search results.

9. The method according to claim 8, comprising
a step of a fixed terminal editing or searching the golf score stored by said server.

10. The method according to claim 8, wherein
said mobile communications radio terminal is a cell phone.

11. The method according to claim 8, further comprising
a step of receiving a charge request from said server, and performing a payment process if a charge is made when said mobile communications radio terminal uses said server.

12. The method according to claim 8, wherein
said server allows golf score information to be cross-referenced among a plurality of mobile communications radio terminals charged by said sponsor terminal.

13. The method according to claim 11, wherein
a user of said sponsor terminal is a golf course, and said mobile communications radio terminal which bears the charge sends golf score card information to said sponsor terminal through said server.

14. A computer-readable program comprising program codes for a method for managing a golf score between a server and a mobile communications radio terminal over the Internet, comprising:
a step of inputting a golf score to the mobile communications radio terminal;
a step of sending an input golf score to said server over the Internet;
a step of said server storing the sent golf score;
a step of said mobile communications radio terminal inputting a search condition and sending the search condition to said server over the Internet;
a step of searching a golf score stored based on the search condition received by said server, and sending search results to said mobile communications radio terminal over the Internet; and
a step of said mobile communications radio terminal displaying the search results.
